(19) United States
(12) Patent Application Publication
(10) Pub. No.: US 2004/0052935 A1
(43) Pub. Date: Mar. 18, 2004

(54) Magnetic thin film and production method therefor

(76) Inventor: Takahashi Migaku, Miyagi-ken (JP)

Correspondence Address: RANDALL J. KNUTH, P.C., 3510-A STELLHORN ROAD, FORT WAYNE, IN, 46815-4631, US

(21) Appl. No.: 10/666,179

(22) Filed: Sep. 18, 2003

Related U.S. Application Data
(63) Continuation of application No. 09/268,948, filed on Mar. 16, 1999.
Application No. 09/268,948 is a division of application No. 08/765,836, filed on Apr. 23, 1997, now abandoned.

(30) Foreign Application Priority Data
Jul. 18, 1994 (WO) PCT/JP94/01173

(51) Int. Cl. B05D 5/12

(52) U.S. Cl. 427/127

(57) ABSTRACT

This invention is directed to provide a thin film of iron nitride of high saturation and low coercive force and a method of forming stable at a high speed a thin film of iron nitride without requiring any specific substrate.

The method of the present invention uses an opposed-target DC sputtering method, in which Ar and N₂ gases are introduced into a film formation chamber, DC power is applied to iron targets in the Ar and N₂ gasses and a thin film of iron nitride is formed on a substrate. A heat treatment is carried out in vacuum after the formation of the thin film.

### CONTINUATION DATA

This is a continuation of U.S. patent application Ser. No. 09/268,948, filed on Mar. 16, 1999, which is a divisional of patent application Ser. No. 08/765,836 filed on Jan. 14, 1997, the disclosure of each of which is herein explicitly incorporated by reference.

### BACKGROUND OF THE INVENTION

1. Field of the Invention

The present invention relates to a magnetic thin film and a manufacturing method therefor; in particular, the present invention relates to a manufacturing method for thin magnetic films which is capable of stably producing an iron nitride film have high saturation. The present invention may be advantageously applied to the magnetic heads or the like of magnetic discs having high recording density.

Iron nitride thin films, in particular, Fe₁₆N₂ thin films, have a particularly large saturation among magnetic materials, and have attracted attention as new materials which may be finely worked for magnetic head materials and the like; however, because these materials are not stable with respect to heat, the formation of thin films under high temperature with such materials is impossible, and the stable formation of thin films having superior characteristics has become difficult. However, in recent years, Omura et al. (Journal of the Japanese Society of Applied Magnetism, 14, 701, 1990) have made it possible to produce a monocrystalline iron nitride film (Fe16N2) using the MBE method, and since the enormous value of the magnetic moment of such a thin film has been confirmed, these materials have again attracted attention, and a manufacturing method which is capable of application has been anticipated.

However, the following problems exist in this manufacturing method: (1) a special substrate (In₀.2Ga_{0.8}AS) is required, (2) the film formation rate is slow (0.05 Å/sec or less), (3) the critical film thickness in the single phase state of the stably formed Fe₁₆N₂ is small (1000 Å or less), and (4) the process of nitridization of the Fe from the gas phase is unclear, and instabilities remain in the thin film formation; thus, the current state of affairs is such that there are great obstacles to the application of iron nitride thin films.

In light of the above circumstances, the present invention has an object thereof to provide a magnetic thin film formation method which is capable of rapidly and stably forming an iron nitride thin film present in a single phase state while at a film thickness of 1000 Å or more, and which does not not require a special substrate. Furthermore, the present invention has an object thereof to provide a magnetic thin film having high saturation and a low coercive force.

2. Description of the Related Art

With respect to a stable formation method for iron nitride thin films, the attention of the present inventors was drawn to the use of a reactive plasma of N₂ gas; they have developed experiments relating to standardized plasma analysis and the process of nitridization by means of a vapor deposition method and sputtering method, and have investigated the relationship between the plasma and the iron nitride thin film phase which is synthesized. The present inventors have selected the plasma conditions and produced the iron nitride thin film on a substrate by means of an opposed-target DC sputtering method have made clear the growth conditions of α″-Fe₁₆N₂, and they have considered the relationships between the phase, the structure, and the saturation. The present invention was completed based on these insights.

That is say, the magnetic thin film of the present invention is characterized in comprising an iron nitride thin film which is formed on a substrate by means of an opposed-target DC sputtering method employing reactive sputtering with N₂ gas.

Furthermore, the present invention is characterized in that by means of the opposed-target DC sputtering method, an iron (α-Fe) thin film and a iron nitride thin film are alternately layered on a substrate.

Furthermore, the magnetic thin film manufacturing method in accordance with the present invention is a manufacturing method for iron nitride thin films which employs an opposed-target DC sputtering method, characterized in that iron nitride thin film is formed on a substrate by introducing Ar and N₂ gases into a film formation chamber, and applying DC power to an iron target within the Ar and N₂ gas atmosphere.

In a preferred mode of the manufacturing method of the present invention, the flow rate of the N₂ is within a range of 8-25% of the total gas flow rate.

Furthermore, it is preferable that the election temperature during formation of the iron nitride thin film be within a range of 0.01-eV, and that the electron density be within a range of 1×10⁹-1×10¹⁰ cm⁻³.

Furthermore, in a preferred mode of the present invention, the substrate has an iron thin film formed thereon as a base layer.

Additionally, in the present invention, it is preferable that after the formation of the iron nitride thin film, heat treatment be conducted in a vacuum, and it is preferable that the heat treatment be such that the temperature is within a range of 100-180° C., and the treatment is conducted for a period within a range of 1-3 hours.

### SUMMARY OF THE INVENTION

By means of the present invention, it is possible to rapidly and stably form an iron nitride thin film having an extremely large saturation Ms, by means of employing an opposed-target DC sputtering method. Additionally, by means of setting the electron temperature and electron density during film formation to within ranges of, respectively, 0.01-1 eV and 1×10⁹-1×10¹⁰ cm⁻³, it is possible to further increase the uniformity and stability of the characteristics of the film, such as saturation and the like.

By means of setting the flow rate of the N₂ gas to within a range of 8-25% of the total gas flow rate, it is possible to more stably form the single phase α crystalline phase.

Furthermore, it is preferable that an iron thin film (a Fe) be formed as a base layer on the substrate. By means of employing such a substrate, the monocrystalline nature of the thin film is further increased.

Additionally, it is preferable that after the iron nitride thin film formation in the present invention, heat treatment be carried out in a vacuum, and it is preferable that the conditions of the heat treatment be such that the temperature is within a range of 100-180° C., and the treatment is carried out for a period of time within a range of 1-3 hours. By means of conducting heat treatment, it is possible to produce an α″ crystalline phase (Fe₁₆N₂) and to further increase the saturation.

By providing a layered structure of α-Fe and iron nitride in the magnetic thin film in accordance with the present invention, it is possible to reduce the coercive force.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a graph showing the relationship between the X-ray diffraction pattern of the iron nitride thin film after film formation, and the flow rate ratio of the N₂ gas during film formation.

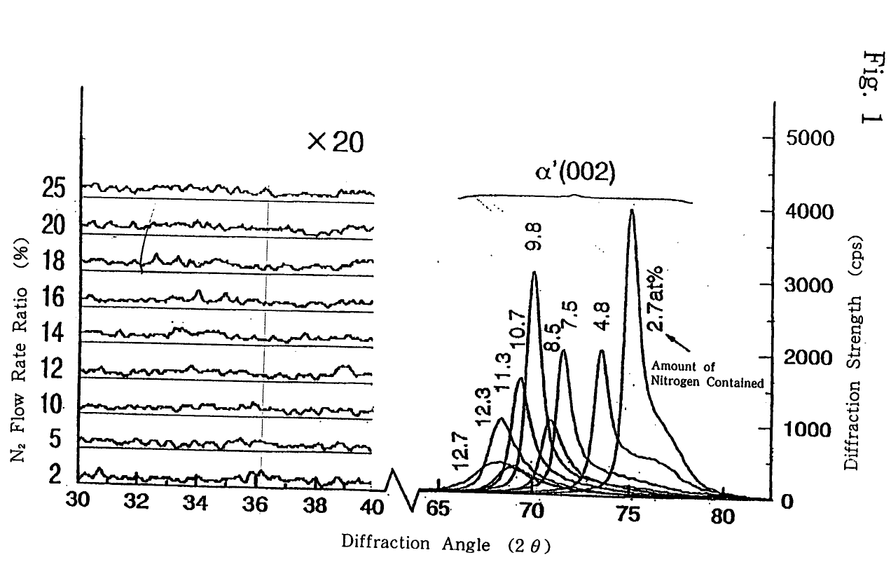

FIG. 2 is a graph showing the X-ray diffraction pattern of the iron nitride thin film after heat treatment.

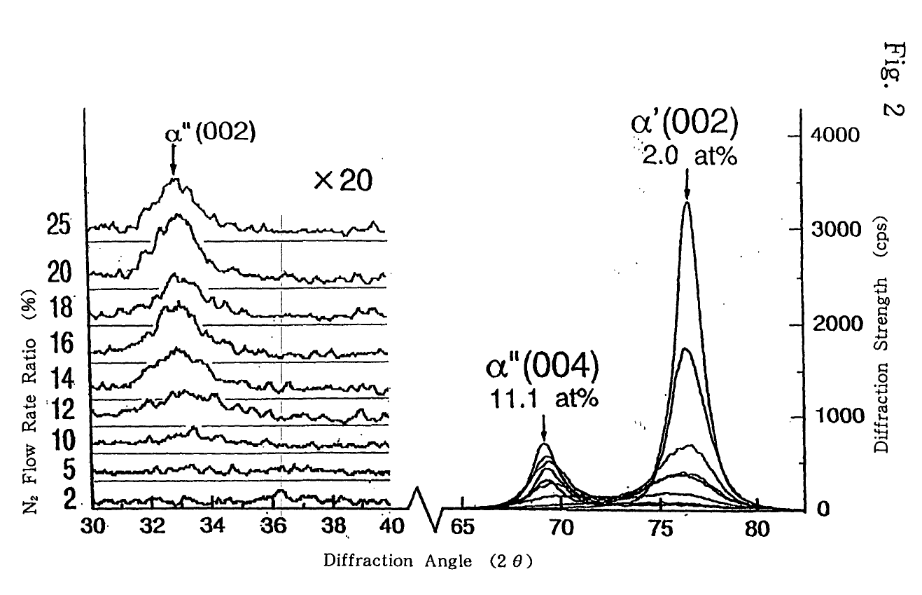

FIG. 3 is a graph showing the changes in the X-ray diffraction pattern of the iron nitride thin film immediately after film formation and after heat treatment.

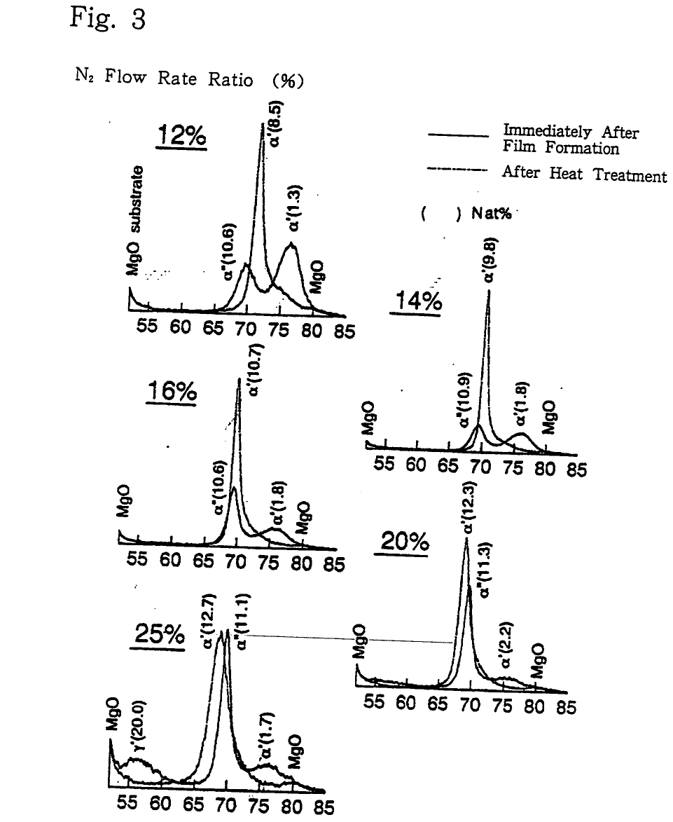

FIG. 4 is a graph showing the relationship between the amount of N contained in the α″ and α′ phases, and the flow rate ratio of the N₂ gas during film formation.

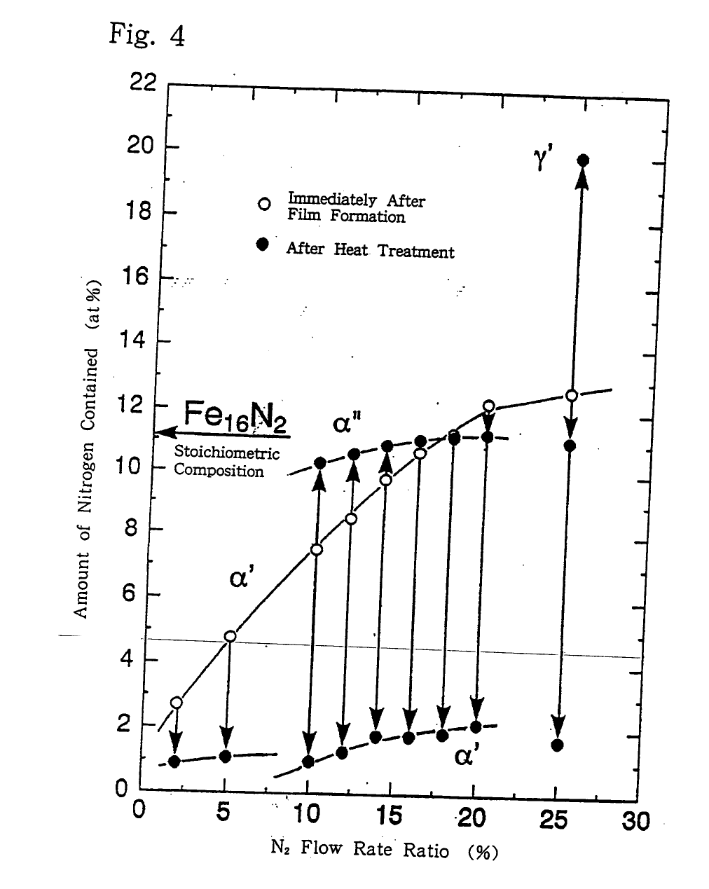

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

As described above, in accordance with the invention as stated in claim 1, it is possible to provide magnetic thin films having high saturation. Additionally, by means of the invention as stated in claim 2, it is possible to provide magnetic thin films having low coercive force.

By means of the magnetic thin film manufacturing method as stated in claim 3, a high speed film formation of 200 Å per minute is possible, and moreover, it is possible to produce iron nitride thin films which are single phase and have high saturations even when extremely thick in comparison with those conventionally obtainable, at 300 Å.

Additionally, in accordance with the invention as stated in claim 8, it is possible to produce a α″ phase having higher saturation.

By means of the present invention, it is possible to provide thin film magnetic heads appropriate for ultra high recording densities.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A magnetic thin film, characterized in comprising an iron nitride thin film formed on a substrate using an opposed-target DC sputtering method by means of reactive sputtering with N₂ gas.

2. A magnetic thin film, characterized in that iron (α-Fe) thin films and iron nitride thin films are alternately deposited on a substrate by means of an opposed-target DC sputtering method.

3. A magnetic thin film manufacturing method comprising a manufacturing method for iron nitride thin films employing an opposed-target DC sputtering method, characterized in that Ar and N₂ gases are introduced into a film formation chamber, DC power is applied to an iron target in the Ar and N₂ gas atmosphere, and an iron nitride thin film is formed on a substrate.

4. A magnetic thin film manufacturing method in accordance with claim 3, characterized in that a flow rate of said N₂ gas is within a range of 8-25% with respect to the total gas flow rate.

5. A magnetic thin film manufacturing method in accordance with one of claims 3 and 4, characterized in that the electron temperature during the formation of the iron nitride thin film is within a range of 0.01-1 eV, and the electron density is within a range of 1×10⁹-1×10¹⁰ cm⁻³.

6. A magnetic thin film manufacturing method in accordance with one of claims 3 through 5, characterized in that said substrate has an iron (α-Fe) thin film (001) surface formed thereon as a base layer.

7. A magnetic thin film manufacturing method in accordance with one of claims 3 through 6, characterized in that after iron nitride thin film formation, heat treatment is conducted in a vacuum.

8. A magnetic thin film manufacturing method in accordance with claim 7, characterized in that the conditions of said heat treatment are such that the temperature is within a range of 100-180° C., and treatment is conducted for a period of time within a range of 1-3 hours.

9. A magnetic thin film manufacturing method in accordance with one of claims 3 through 8, characterized in that said iron nitride thin film contains an α″ crystalline phase (Fe₁₆N₂)
